(19) United States
(12) Patent Application Publication
(10) Pub. No.: US 2009/0117009 A1
(43) Pub. Date: May 7, 2009

(54) MULTI-CHANNEL ELECTRONIC PIPETTOR

(76) Inventor: Richard Cote, Bolton, MA (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/934,646

(22) Filed: Nov. 2, 2007

(51) Int. Cl. B01L 3/02

(52) U.S. Cl. 422/100

(57) ABSTRACT

A multi-channel electronic pipettor has a removable lower multi-channel assembly to facilitate autoclaving. The pipettor includes a position holding mechanism which allows adjustment of the angular position of the lower multi-channel assembly with respect to the handle assembly. The lower multi-channel assembly includes a cylinder block including a plurality of aspiration cylinders along with a plurality of pistons, a series of pipette tip mounting shafts and a manifold to communicate between the aspiration cylinders and the air passageways in the pipette tip mounting shafts, among other components. The volume of the air passageways in the manifold is balanced among channels to improve tip-to-tip pipetting accuracy. In addition, the lower multi-channel assembly includes an internal frame to which the other components, such as a cylinder block, are attached either directly or indirectly.

### FIELD OF THE INVENTION

The invention relates to improvements in hand-held, multi-channel electronic pipettors.

### BACKGROUND OF THE INVENTION

Hand-held, electronic pipettors are normally programmed through the use of a user interface on the pipettor itself. The user programs the pipettor to aspirate a selected volume of liquid and to dispense the aspirated volume sometimes as a series of aliquots in successive dispensing operations. Programmable electronic pipettors can also be configured to do more complex operations such as mixing, repeat pipetting, diluting, etc.

Multi-channel pipettors typically have 8, 10, 12 or 16 mounting shafts for disposable pipette tips. The multiple pipette tips enable a user to transfer multiple samples or reagents from one series of containers to another, such as from one series of wells in a microtiter plate to another series of wells in a microtiter plate. In laboratory procedures using hand-held, multi-channel electronic pipettors, the aspirated and dispensed volumes among the multiple pipette tips is typically equal. Thus, it is desirable to minimize the amount of variability as to aspiration and dispensing volumes among channels. In fact, acceptable tolerances for many laboratory procedures have become more strict in recent years, especially with respect to protocols that require the transfer of smaller liquid volumes. Mechanical variability among the channels can lead to unbalanced pipetting accuracy.

Most hand-held, multi-channel pipettors use an electronically controlled stepper motor to move a main piston shaft up and down to control the aspirating of liquid into the pipette tip, dispensing of liquid, and purging the tips prior to ejection. One common configuration employs a cylinder block having a plurality of aspiration cylinders each containing a piston. Typically, the main piston drive shaft, which is driven by the electronically controlled stepper motor, is attached to a piston drive plate from which the multiple pistons extend downward.

It is desirable that the lower multi-channel assembly, which contains the aspiration cylinders, pistons, and the pipette mounting shafts, be removable from the upper handle assembly so that the lower multi-channel assembly can be autoclaved. It is also desirable that the lower multi-channel assembly have a robust and compact design. Designing a compact lower multi-channel assembly is difficult, in part, because it must not only include aspiration cylinders and pistons, spaced mounting shafts and a manifold between the aspiration cylinders and the mounting shafts, but also an effective ejection mechanism for the pipette tips. Some lower assemblies in multi-channel pipettors tend to be too bulky for the user to easily view the pipette mounting shafts or disposable tips mounted on the shafts.

In some multi-channel pipettors, the housing for the lower drive unit is used as a structural component for the ejection mechanism, and thus moves upward and downward to eject the pipette tips. While somewhat satisfactory, this design is not particularly robust.

### SUMMARY OF THE INVENTION

The invention pertains to the design and configuration of a lower assembly for hand-held, multi-channel electronic pipettors, and the manner in which the lower assembly attaches to the handle assembly.

The preferred multi-channel electronic pipettor has a handle assembly containing a motor. The motor moves an output shaft upward to aspirate and downward to dispense. The pipettor also has a lower multi-channel assembly which includes a main piston drive shaft attached at its upper end to the output shaft of the handle assembly and at its lower end to a piston drive plate. Multiple pistons extend downward from the piston drive plate. The lower multi-channel assembly also includes a cylinder block having multiple aspiration cylinders. Each piston is disposed for reciprocating movement within one of the aspiration cylinders. The lower multi-channel assembly also has a plurality of pipette mounting shafts located in an equally spaced linear series at the bottom of the lower multi-channel assembly. A manifold connects the aspiration cylinders to the pipette mounting shafts. The manifold has a plurality of air flow passageways each connecting a bottom portion of one of the multiple aspiration cylinders to an internal air flow duct of one of the pipette tip mounting shafts.

In one aspect of the invention, the invention relates to a manifold in which the volume of the air flow passageways through the manifold are balanced for each channel, even though some mounting shafts are located closer to the respective aspiration cylinder than other mounting shafts are to their respective cylinder. Maintaining balanced volumes in the manifold has been found to improve the tip-to-tip pipetting accuracy, especially when small volumes are transferred. The preferred manifold comprises an upper manifold plate made of molded fiber-filled polypropylene, a sealing gasket and a lower manifold plate. The sealing gasket and the lower manifold plate include openings that correspond to the location of the internal passageways of the respective series of pipette mounting shafts. The upper manifold plate preferably includes a plurality of channels on its bottom surface which are sealed by the gasket sandwiched between the upper manifold plate and the lower manifold plate. Preferably, a beaded edge extends around each channel in the upper manifold plate in order to ensure a secure seal with the gasket. The preferred upper manifold plate also includes an opening and a coincidental volume adjusting chamber on its top surface. The hole and chamber on the top surface correspond to the location of the respective aspiration cylinders and communicate with the beginning of a respective channel on the bottom surface of the upper manifold plate. The size of the chambers in the upper manifold plate is selected so that the combined volume of the chamber and channel through the upper manifold plate is consistent from one set to the next, thereby balancing the volume between each respective aspiration cylinder and the mounting shaft. The use of an upper and lower manifold plate as described is useful, however, even in applications in which it is not necessary to balance the volume of the air passageways through the manifold.

In another aspect of the invention, the lower multi-channel assembly includes an internal frame to which the aspiration cylinder block is attached. The preferred frame includes a top wall having an opening through which the main piston drive shaft resides and first and second sidewalls extending downward from the top wall. The cylinder block is attached securely to each of the first and second sidewalls of the frame. The manifold is preferably attached to the cylinder block, and the mounting shafts for the pipette tips are mounted to the manifold. The housing for the lower multi-channel assembly is essentially cosmetic, although the housing does provide shelter for the internal components of the lower multi-channel assembly. The ejection mechanism in the drive assembly includes a stripper bar that is attached to two ejector rods that are slidably mounted through the manifold, cylinder block and frame. The ejector bars preferably engage a circular collar on the handle assembly which is moved by an ejection mechanism in the handle assembly up and down in order to provide ejection force to the push bars and the ejection mechanism in the lower multi-channel assembly. This configuration allows for a relatively tight fit for the slidable ejector rods which lends itself to a sturdy yet compact design.

In another aspect of the invention, the lower multi-channel assembly is mounted to the handle assembly in such a way that the user can rotate the lower multi-channel assembly along a longitudinal axis and vary the angular position of the lower multi-channel assembly relative to the handle assembly. Users may desire to change the angular position to enable better visibility of the pipette tip mounting shafts, or simply for convenience or ergonomic reasons. In this regard, the pipettor further comprises a position holding mechansim, preferably a spring loaded position holding mechanism that allows the user to hold the relative angular position of the lower multi-channel assembly with respect to the handle assembly and also allows the user to change the angular position. The position holding mechansim preferably includes a first ratcheting surface facing downward from the bottom of the handle assembly and a mating ratcheting surface facing upward from the lower multi-channel assembly which, when engaged, hold the relative position of the lower multi-channel assembly with respect to the handle assembly in a fixed angular position.

It is also preferred that the lower multi-channel assembly be easily removable from the handle assembly, e.g. to facilitate autoclaving. The handle assembly would typically include, among other components, an electronically controlled stepper motor, a programmable microprocessor, a display screen, a user interface and the corresponding electronics, and electronic memory. Many of these components in the handle assembly are not suitable for autoclaving. Several features of the pipettor facilitate the removability of the lower drive unit, while at the same time preserving the ability to change the angular position of the lower multi-channel assembly. In this regard, the preferred multi-channel pipettor also includes a rotational stop mechanism as part of the mounting configuration in the handle assembly. The stop mechanism allows the lower assembly to rotate relative to the handle assembly about the longitudinal axes of the output and piston shafts, but for less than one full revolution, e.g. about 320°. When the lower multi-channel assembly is rotated to such an extent that it engages the stop mechanism, the user is able to unscrew the threaded connection that connects the upper handle assembly to the lower multi-channel assembly and remove the lower multi-channel assembly.

One embodiment of the invention uses a first magnet on the distal end of the output shaft from the handle assembly and another magnet which is attracted to the first magnet is attached on an upper end of the main piston drive shaft. The magnets attach the respective shafts for up and down movement along the longitudinal axes of the shafts, but allow the main piston drive shaft in the lower multi-channel assembly to rotate about the longitudinal axis with respect to the output shaft of the handle assembly. As an alternative, a ball and socket configuration can be used to attach the output shaft from the handle assembly to the main piston drive shaft of the lower multi-channel assembly. Also, as previously mentioned, the ejector actuation mechanism in the handle assembly includes a substantially circular ejector collar that provides a smooth, consistent interface for engaging the ejector rods on the lower multi-channel assembly throughout the full range of available angular positions for the lower multi-channel assembly.

Also, as will be apparent from the following description, the attachment of the lower assembly to the upper assembly essentially provides a unitary structural frame from the motor to the pipette mounting shafts. This feature provides substantial mechanical stability and feel.

Other aspects and features of the invention may be apparent to those skilled in the art upon reviewing the following drawings and description thereof.

### BRIEF DESCRIPTION OF THE DRAWINGS

FIG. 1 is a perspective view of a hand-held, multi-channel electronic pipettor constructed in accordance with the preferred embodiment of the invention.

FIG. 2 is a schematic view similar to FIG. 1 illustrating that a lower multi-channel assembly of the pipettor can be rotated with respect to the handle assembly.

FIGS. 3a-3c are detailed views illustrating components of a position holding mechansim for attaching a lower multi-channel assembly to a handle assembly as shown in FIGS. 1 and 2.

FIG. 4 is a schematic perspective view of the internal components of the handle assembly of the multi-channel pipettor shown in FIGS. 1 and 2.

FIG. 5 is a side elevational view of portions of the multi-channel pipettor shown in FIG. 1 with the upper and lower housings broken away to show the internal components.

FIG. 6 is a schematic view illustrating the operation of the ejector mechanism for the multi-channel pipettor shown in FIG. 1.

FIGS. 7 and 8 are perspective views of the internal components of the lower multi-channel assembly of the pipettor shown in FIG. 1.

FIG. 9 is an exploded view of the internal components of the lower multi-channel assembly of the pipettor shown in FIG. 1.

FIG. 10 is an exploded view of the piston assembly shown assembled in FIG. 9.

FIG. 11 is an exploded view of additional components in the lower multi-channel assembly shown in FIG. 9.

FIG. 12 is a perspective view of a top surface of an upper manifold plate similar to the upper manifold plate illustrated in FIG. 11, except that it is designed for a 12-channel pipettor rather than a 16-channel pipettor as is illustrated in FIG. 1.

FIG. 13 is a perspective view of the bottom surface of the upper manifold plate shown in FIG. 12.

FIG. 14 is a schematic drawing illustrating the air flow channels and volume adjusting chambers in the upper manifold plate shown in FIGS. 12 and 13.

FIG. 15 is a sectional view of the upper manifold plate taken along line 15-15 in FIG. 14.

FIG. 16 is a sectional view taken along line 16-16 in FIG. 14.

FIG. 17 is a sectional view taken along line 17-17 in FIG. 14.

FIG. 18 is a schematic view illustrating that the lower multi-channel assembly can be removed from the handle assembly and replaced with another lower multi-channel assembly.

### DETAILED DESCRIPTION OF THE INVENTION

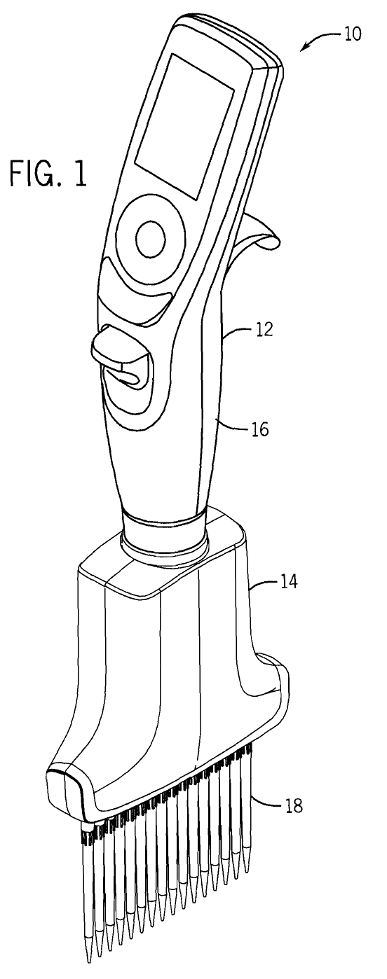

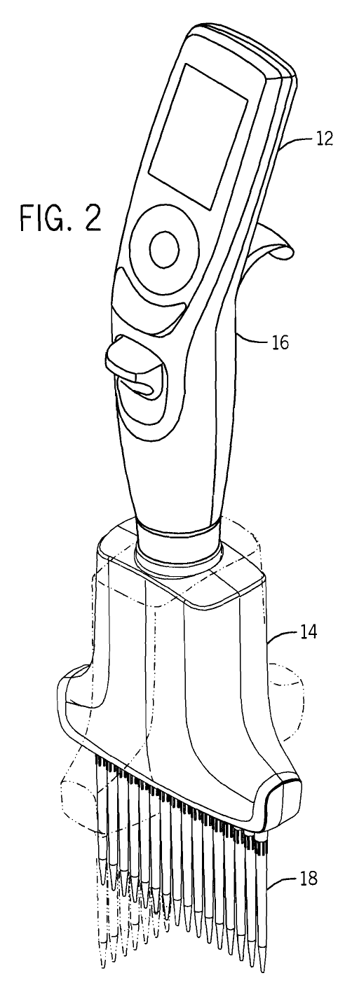

FIG. 1 illustrates a hand-held, multi-channel electronic pipettor 10 constructed in accordance with the preferred embodiment of the invention. The pipettor 10 shown in FIG. 1, as well as the following FIGS. 2-11 illustrate a 16-channel pipettor 10 which has a center-to-center spacing of 4.5 mm between tips. The invention, however, is not limited to pipettors having 16 channels, and while it is preferred that the center-to-center spacing between the tips be commensurate with normal industry standards such as 4.5 mm or 9 mm, the invention is not limited thereto.

The multi-channel pipettor 10 includes an upper handle assembly 12 and a lower multi-channel assembly 14. As shown in FIG. 2, it is preferred in accordance with one aspect of the invention that the angular position of the lower multi-channel assembly 14 be adjustable, with respect to the orientation of the upper handle assembly 12. The upper handle assembly 12 includes a housing 16 that is designed to be held in the palm of the user. Internal components contained within the upper housing assembly 12, as discussed below, include an electronically controlled stepper motor 56 that drives an output shaft 20 up and down in order to aspirate and dispense. The lower multi-channel assembly 14 includes a plurality of mounting shafts 86 for a series of disposable pipette tips 18. As will be discussed below, the internal components of the lower multi-channel assembly 14 include a main piston drive shaft 22 that is connected to the output shaft 20 from the upper housing assembly 12, an array of pistons 106 which extend downward from a piston drive plate 104 and are driven by the main piston drive shaft 22, a cylinder block 84 containing a plurality of aspiration cylinders 96, a plurality of pipette tip mounting shafts 86 and a manifold 88 communicating between the aspiration cylinders 96 and the pipette mounting shafts 86, as well as other components, as will be discussed herein.

In the preferred embodiment, the multi-channel pipettor 10 includes many features discussed in copending patent applications, all of which are assigned to the assignee of the present application and incorporated herein by reference. Briefly, with respect to the upper handle assembly, its operation in the preferred embodiment is described in copending patent application entitled “Electronic Pipettor Assembly”, application Ser. No. 11/856,231 by Gary E. Nelson, George P. Kalmakis, R. Laurence Keene, Joel Novak, Kenneth Steiner, Jonathon Finger, Gregory Mathus and Richard Cote, filed Sep. 17, 2007, assigned to the assignee of the present application and incorporated herein by reference, and copending application entitled “Pipettor Software Interface”, application Ser. No. 11/856,232 by George Kalmakis, Gary Nelson;, Gregory Mathus, Terrence Kelly, Joel Novak, Kenneth Steiner and Jonathan Finger, filed Sep. 17, 2007, assigned to the assignee of the present application and incorporated herein by reference. The preferred configuration for the pipette tips and the pipette tip mounting shafts is disclosed in copending patent application entitled “Locking Pipette Tip and Mounting Shaft”, application Ser. No. 11/552,384 by Gregory Mathus, Terrence Kelly and Richard Cote, filed Oct. 24, 2006, assigned to the assignee of the present application and incorporated herein by reference, and Continuation-In-Part application Ser. No. 11/934,381, entitled “Locking Pipette Tip and Mounting Shaft”, by Gregory Mathus, Terrence Kelly and Rich Cote, filed on even date herewith, which is also assigned to the assignee of the present application and incorporated herein by reference. The preferred ejection mechanism for the multi-channel pipettor 12 is disclosed in copending patent application entitled “Pipette Tip Ejection Mechanism”, application Ser. No. 11/856,193 by Gregory Mathus and Richard Cote, filed Sep. 17, 2007, which is assigned to the assignee of the present application and also incorporated herein by reference.

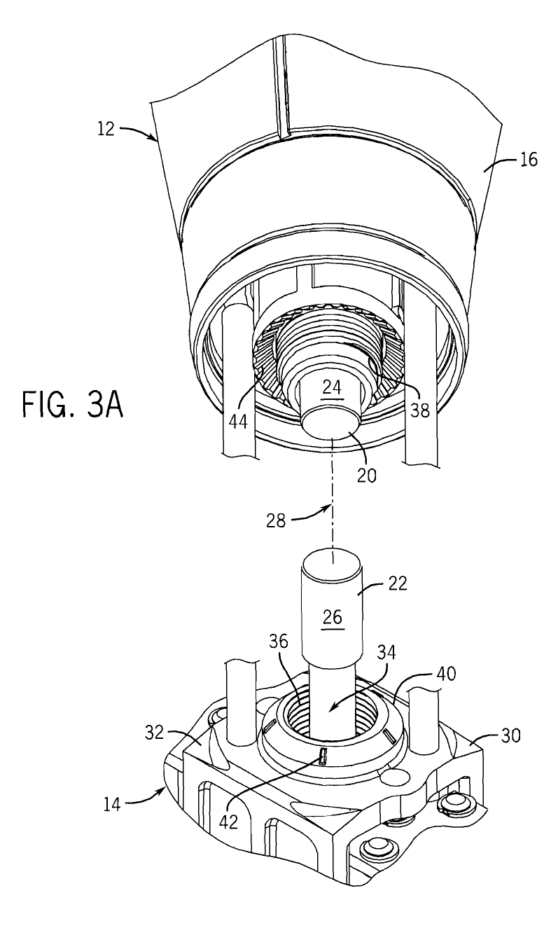

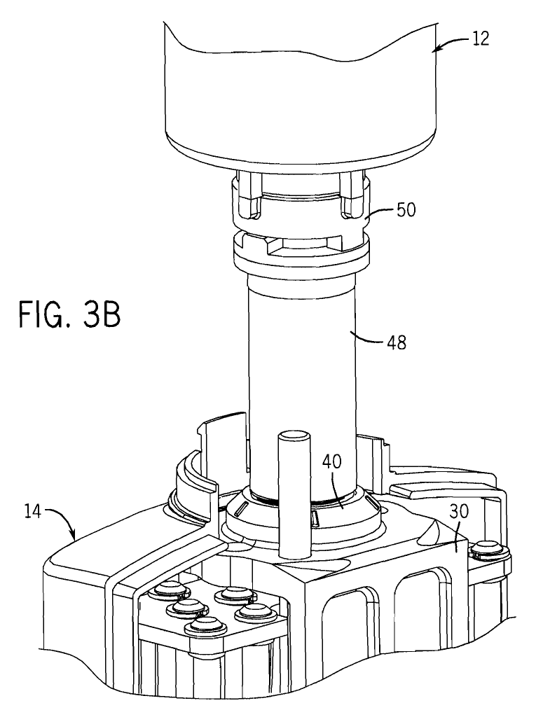

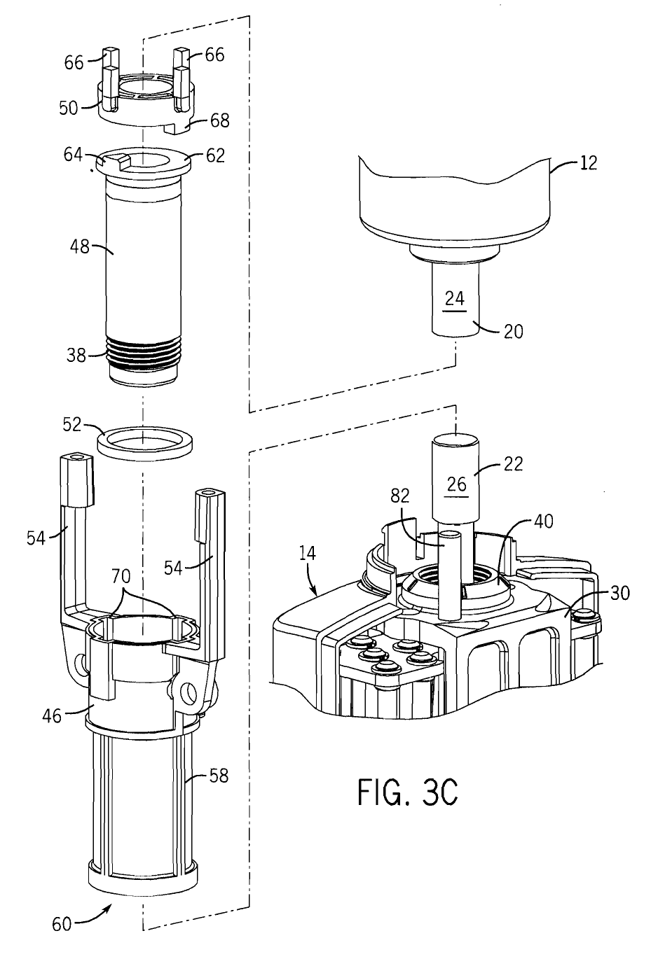

FIGS. 3a-3c illustrate the connection of the lower multi-channel assembly 14 to the upper handle assembly 12. The handle assembly 12 includes an output shaft 20 that is driven up and down by the electronically controlled motor 56 (not shown in FIGS. 3a-3c). When the lower multi-channel assembly 14 is attached to the handle assembly 12, the output shaft 20 engages a main piston drive shaft 22 on the lower multi-channel assembly 14. In the embodiment shown, a magnet 24 is located at the distal end of the output shaft 20 on the handle assembly 12, and another magnet 26 is attached to the top end of the main piston drive shaft 22 of the lower multi-channel assembly 14. The magnets 24 and 26 attract one another so that the shafts 20 and 22 move together up and down along a longitudinal axis 28 when the lower multi-channel assembly 14 is attached to the handle assembly 12. While the use of magnets 24, 26 are suitable for attaching shafts 20 and 22, it may be desirable in some circumstances to replace the magnets 24, 26 with a ball and socket design. For example, it may be desirable to replace the magnet 24 on the handle assembly 12 with a ball, and replace the magnet 26 on the lower multi-channel assembly 14 with a socket. In such a design, the ball is received preferably from the side of the socket, and a plunger is used to secure the ball within the socket.

As shown in FIG. 3a, the lower multi-channel assembly 14 includes a frame 30 that includes a top wall 32 with a central necked opening 34 through which the main piston drive shaft 22 resides. The necked opening 34 in the frame 30 is a circular, threaded opening. The threads on the frame 30 are depicted by reference number 36. The handle assembly 12, on the other hand, includes a male threaded portion 38. The user attaches the lower multi-channel assembly 14 to the upper handle assembly 12 by screwing the threads 38 on the handle assembly 12 into the threaded portion 36 on the frame 30 of the lower multi-channel assembly 14.

As mentioned, the pipettor 10 also includes a position holding mechansim that allows the user to adjust the angular position of the lower multi-channel assembly 14 relative to the handle assembly 12. In this regard, the lower multi-channel assembly includes a ratcheting washer 40 that is preferably slidably mounted around the threaded neck 36 of the frame 30. The ratcheting washer 40 includes an upwardly facing chamfered surface having several ratcheting protrusions 42. While it is possible to attach the ratcheting washer 40 to the frame 30 or make it integral with the frame 30, it has been found desirable for tightening purposes to allow the ratcheting washer 40 to slide with respect to the frame 30 when the lower multi-channel assembly 14 is being tightened onto the handle assembly 12. The handle assembly 12 includes a downwardly facing ratcheting surface 44. The ratcheting surface 44 engages the ratcheting protrusions 42 when the lower multi-channel assembly 14 is attached to the handle assembly 12 to fix the angular position of the lower assembly 14.

Referring now in particular to FIG. 3c, the handle assembly 12 includes a motor chassis 46, an attachment collar 48, a locking ring 50, and a wave spring 52. The motor chassis 46 is stationary within the handle assembly 12. It includes two upwardly extending and spaced apart arms 54 which define a space in which the motor 56 is mounted. Below this space, the motor chassis 46 consists of a generally tubular frame portion 58 through which the output shaft 20 from the motor 56 extends. The ratcheting surface 44 shown in FIG. 3a on the handle assembly 12 is present on the bottom surface of the motor chassis 46. The tubular portion 58 of the motor chassis 46 includes a shelf (not shown) which receives the wave spring 52 and the attachment collar 48. Note that the threaded portion 38 on the handle assembly 12 shown in FIG. 3a is located on the attachment collar shown in FIG. 3c. The attachment collar 48 includes an outwardly extending rim 62 at its upper end. An upwardly facing stop 64 extends upward from the rim 62 on the attachment collar 48. The threads 38 on the attachment collar 48, as well as the mating threads 36 on the frame 30 for the lower multi-channel assembly 14, are designed so that the threads bottom-out when fully tightened to provide clearance for the wave spring 52 that does not over-compress the wave spring 52 between the rim 62 on the attachment collar 48 and the shelf within the motor chassis 46. The preferred wave spring provides 9 lbs. of biasing force. Use of the wave spring 52 essentially pushes the attachment collar 48 as well as the lower multi-channel assembly 14 slightly upward with respect to the motor chassis 46. In effect, the wave spring 52 biases the ratcheting surface 42 on the ratcheting washer 40 on the lower multi-channel assembly upward towards the ratcheting surface 44 on the bottom surface 60 of the motor chassis 46, and also eliminates the buildup of manufacturing tolerances.

The attachment collar 48 is generally allowed to rotate freely within the motor chassis 46 for slightly less than one revolution, e.g. about 320°. The locking ring 50 includes four posts 66 which extend upward, as well as downwardly extending stop 68. The motor chassis includes detents 70 at its upper end to receive the posts 66 on the locking ring 50. The locking ring 50 is thus mounted to be stationary within the top end of the motor chassis 46. The downwardly extending stop 68 on the locking ring 50 serves to stop rotation of the attachment collar 48 when the stop 68 on the locking ring 50 engages the upwardly protruding stop 64 on the attachment collar 48. As mentioned, the attachment collar 48 is thus able to rotate with respect to the motor chassis 46 for slightly less than one full revolution. Although not shown specifically in the drawings, it is preferred that the ratcheting washer 40 on the lower multi-channel assembly 14 be keyed to rotate with the attachment collar 48. The user can thus rotate the lower multi-channel assembly 14 with respect to the handle assembly 12 within the range of motion provided by the stops 64 and 68, and reposition the ratcheting washer 40 with respect to the ratcheting surface 44 on the motor chassis 46. However, once the stops 64 and 68 engage, further rotation will cause the threads 38 and 36 to loosen or tighten, depending on the direction of rotation. Note that FIG. 3b shows the lower multi-channel assembly 14 attached to the handle assembly 12, but the motor chassis 46 has been removed to illustrate the attachment of the attachment collar 48 to the frame 30.

It is important to also note that the motor chassis 56, the internal frame 30 on the lower assembly, the cylinder block 84 and the manifold 88 are attached when the lower assembly 14 is threaded onto the handle assembly 12. This combination essentially forms a unitary structural frame for the pipettor 10 that extends for the motor 56 to the pipette mounting shafts 86, and provides the pipettor 10 with exceptional stability and feel.

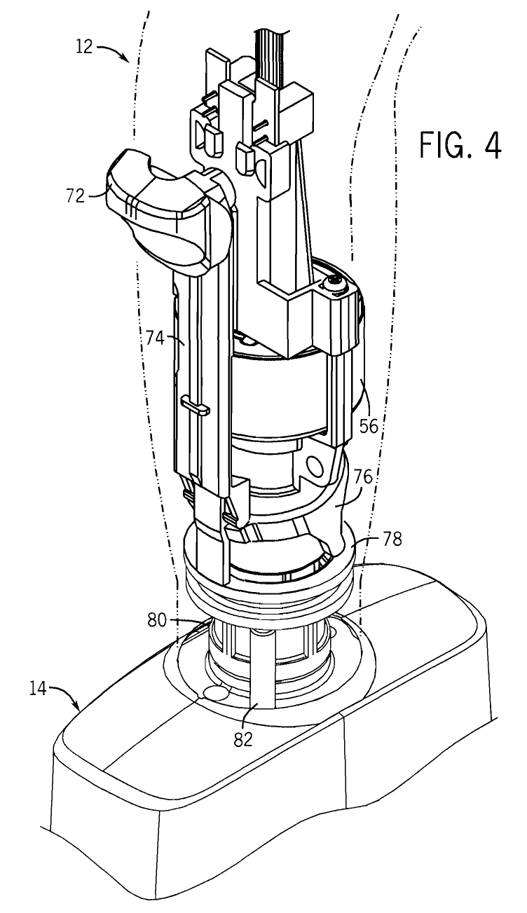

Referring now to FIGS. 4-6, the ejection mechanism is described briefly. As previously mentioned, the details of the preferred tip ejection mechanism are described in copending patent application entitled “Pipette Tip Ejection Mechanism”, Ser. No. 11/856,193 by Gregory Mathus and Richard Cote, filed Sep. 17, 2007, which is assigned to the assignee of the present application and incorporated herein by reference. Generally speaking, the ejection mechanism in the handle assembly 12 includes an ejector button 72, an activation bar 74, a rocker arm 76 and a circular collar 78. Up and down movement of the collar 78 is produced either by engagement with the rocker arm 76 or directly by the bar 74, depending on the range of motion of the actuation button 72. Of particular importance for the present invention, the circular collar 78 has a lower surface 80 which engages the top end of the ejector push rods 82 on the lower multi-channel assembly 14, no matter the adjusted angular position of the lower multi-channel assembly with respect to the handle assembly 12. As described in the above copending patent application, the push rods 82 are spring loaded to be constantly in engagement with the lower surface 80 of the circular collar 78.

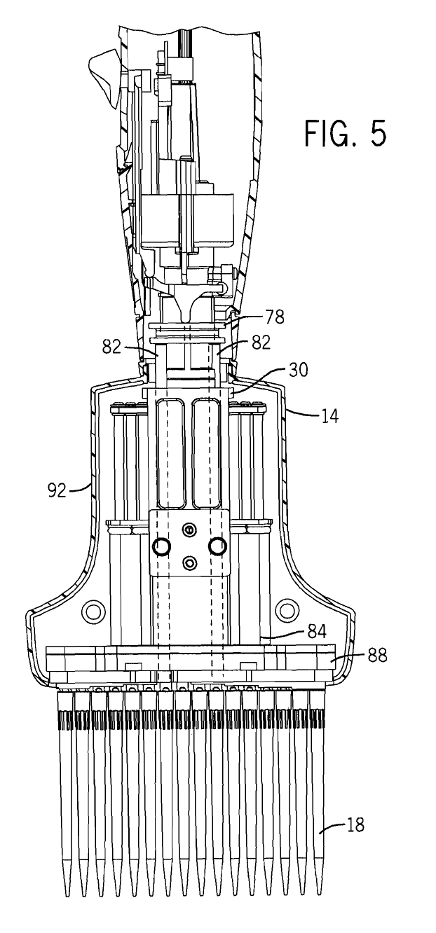

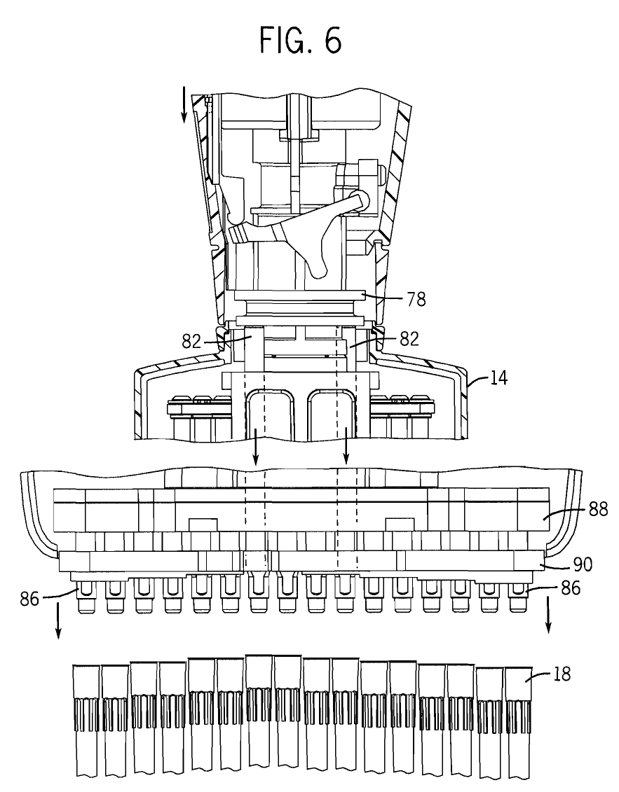

Referring in particular to FIGS. 5 and 6, the lower multi-channel assembly includes a cylinder block 84 that is attached to the internal frame 30, a plurality of mounting shafts 86 for the pipette tips, as well as a manifold 88. The ejector push rods 82 are connected to a stripper bar 90. As shown in FIG. 6, when the ejection mechanism pushes downward, the collar 78 presses downward on the ejector push rods 82 in the lower housing which pushes the stripper bar 90 downward to remove the pipette tips 18 from the mounting shafts 86. Details of the ejector mechanism are described in the above copending patent application. Of note with respect to the present invention is that the ejector push rods 82 in the lower multi-channel assembly 14 extend upward from the stripper bar through the manifold 88, the cylinder block 84 and through openings in the piston drive plate and the top wall of the frame 30. While the ejector rods 82 are able to slide through these components, the fit can be made relatively tight, thereby rendering the design robust, sturdy and compact. Note that the housing 92 for the lower multi-channel assembly is stationary and is primarily cosmetic aside from sheltering the components from the pipettors' environment.

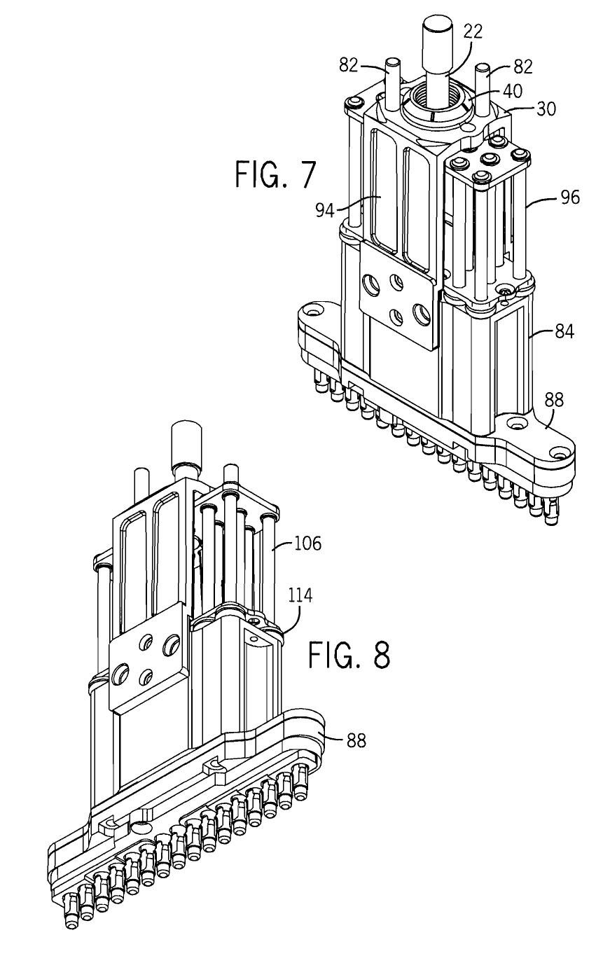

FIGS. 7-9 illustrate the internal components of the lower multi-channel assembly 14. The internal frame 30 has a top wall 32, as mentioned previously, and two sidewalls 94 extending downward from the top wall 32. The cylinder block 84 contains a plurality of aspiration cylinders 96, FIG. 9. The cylinder block 84 is attached directly to the lower end of the sidewalls 94 of the internal frame 30. The sealed piston assembly 96 is mounted to the top of the cylinder block 84 and the manifold 88 is mounted to the bottom of the cylinder block 84. The mounting shafts for the pipette tips 86, as mentioned, are mounted to the manifold 88. The preferred configuration of the mounting shafts is described in copending continuation-in-part patent application entitled “Locking Pipette Tip And Mounting Shaft”, application Ser. No. 11/934,381, filed on even date herewith, which is assigned to the assignee of the present application and incorporated herein by reference. The assembly drawing of FIG. 9 also shows springs 98 and lock rings 100 which are used to bias the ejection push rods 82 in an upward position. Note that the ejector rods 82 include a groove 102 that receives the snap rings 100.

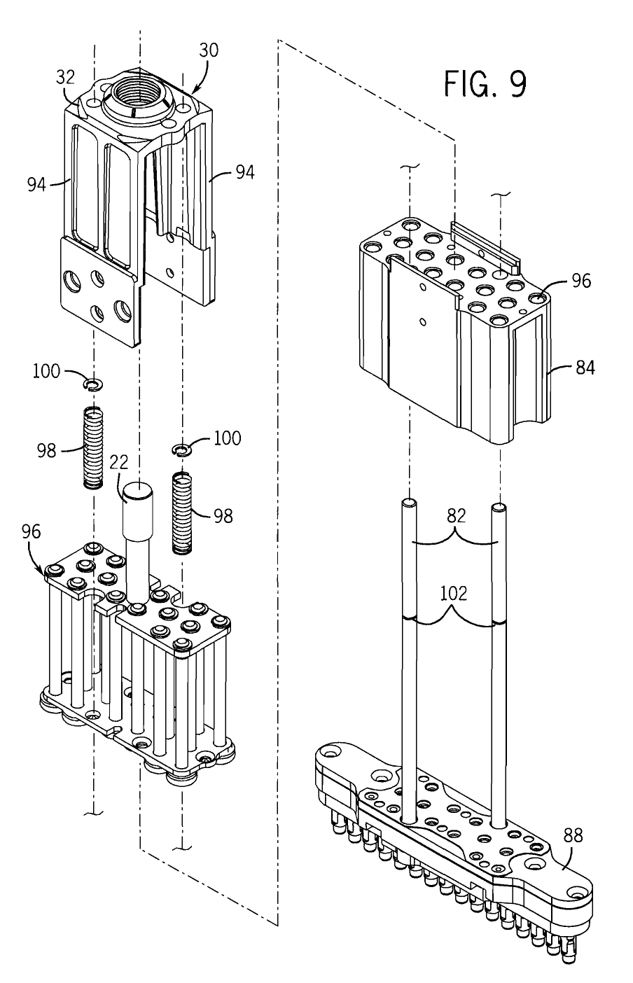

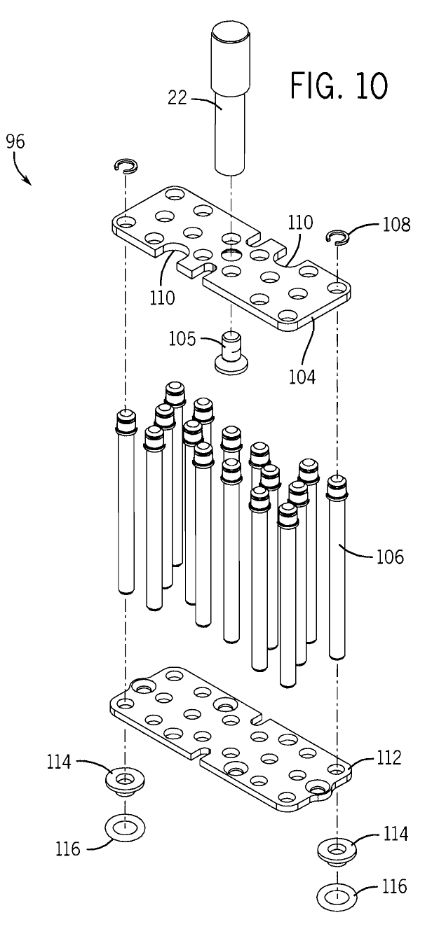

Referring to FIG. 10, the preferred piston assembly includes a main piston drive shaft 22 that is attached to a piston drive plate 104 using a screw 105. A plurality of pistons 106 are attached to the drive plate 104 for example using snap rings 108. The drive plate 104 also includes openings 110 to provide clearance for the ejector push rods 82. The piston assembly 96 also includes a seal hold down plate 112 which has a plurality of openings for the pistons 106. A seal and washer 114, 116 are provided for each piston 106. The seal hold down plate 112 is attached to the upper surface of the cylinder block 84, see FIG. 9, with the respective seals and washers 114, 116 sandwiched therebetween. Other suitable sealing arrangements may be used in accordance with the invention, if desired. The pistons 106 and the main piston drive shaft 22 as well as the plates 104 and 112 are preferably made of steel, as is known in the art, and the seals 114 are preferably made of an elastomeric material, as also is known in the art, although other materials may be used if suitable.

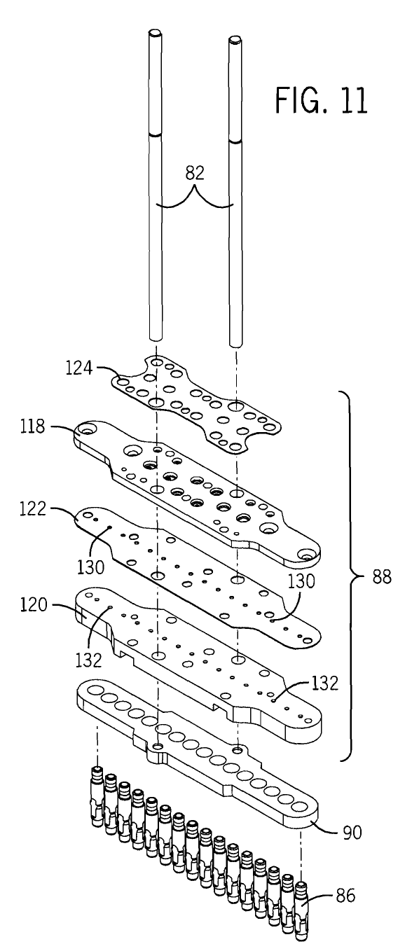

FIG. 11 is an assembly drawing of the components of the manifold 88 and the ejector mechanism 82, 90 for the lower multi-channel assembly. The manifold 88 consists of an upper manifold plate 118, a lower manifold plate 120, and a gasket 122 sandwiched between the upper manifold plate 118 and the lower manifold plate 120. A silicone seal 124 is preferably installed between the upper manifold plate 118 and the bottom surface of the aspiration cylinder block 84. The manifold 88 provides a plurality of air flow passageways between the respective aspiration cylinders 96 in the cylinder block 84 and the internal air flow ducts that pass through the center of the pipette mounting shafts 86. The upper manifold plate is preferably made of molded fiber-filled polypropylene.

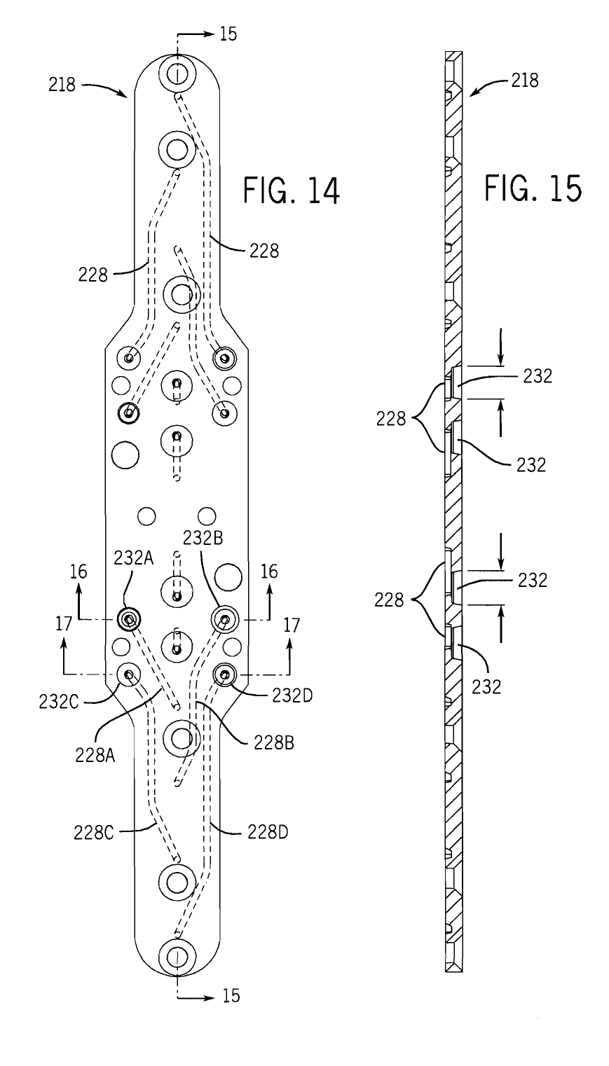

FIGS. 14-17 show an upper manifold plate 218 for a 12-channel pipettor. While the drawings in FIGS. 1-11 illustrate a 16-channel pipettor, the concepts of the invention relating to the upper manifold plate 118, 218 are shown in FIGS. 14-17 with respect to a 12-channel pipettor for the sake of simplicity.

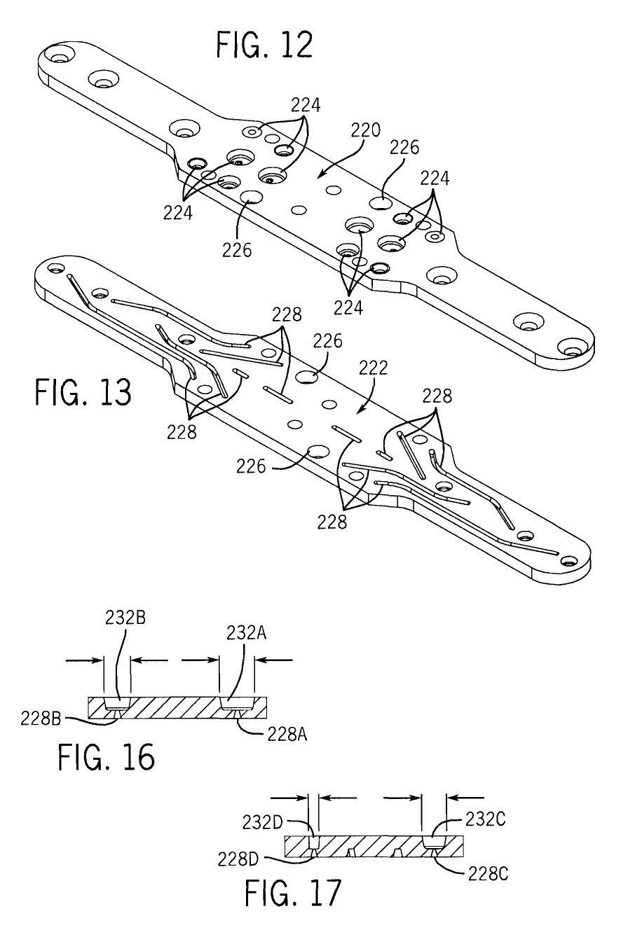

The upper manifold plate 218 has an upper surface 220, FIG. 12 and a lower surface 222, FIG. 13. Referring to the upper surface 220, there are a plurality of holes that correspond to the center line location of the cylinders 96 in the aspiration cylinder block 84. The holes in the upper surface 220 are depicted by reference numeral 224. Holes 226 in the manifold plate are for the ejector rods 82, and the other holes are for fasteners to secure the manifold to itself and to the cylinder block.

The bottom surface 222 of the upper manifold plate shown in FIG. 13 has channels 228 which extend from the holes 224 corresponding to the location of the bottom of the cylinders 96 in the aspiration cylinder block 84 to a location corresponding to the inlet for the respective mounting shafts 86. Preferably, although not shown in the drawings, each channel 228 has a beaded edge. Referring briefly to FIG. 11, the upper manifold plate 118, 218 is attached to the lower manifold plate 120 with the gasket 122, preferably made of silicone, secured tightly therebetween. The beaded edges surrounding the channels 228 facilitate effective sealing of the lower surface 222 of the upper manifold 118 against the gasket. The beaded edges are preferably rounded and have a height of about 0.012 inches and a width of about 0.020 inches. Note that the gasket 122 includes a series of openings 130 corresponding to the end location of the channels 228, i.e. the location corresponding to the inlet for the pipette mounting shafts 86. Likewise, the lower manifold plate 120 includes a series of openings 132 that correspond to the location of the pipette mounting shafts 86. As an alternative to using a gasket 122, it may be desirable to attach the upper manifold plate and the lower manifold plate via ultrasonic or heat welding, or with adhesive. Moreover, if the cylinder block is made of a plastic material, it may be desirable to attach the manifold via welding or with adhesive. The cylinder block may be made of any suitable material, for example molded plastic or aluminum.

As can be seen in FIGS. 13 and 14, the length of the channels 228 in the manifold varies substantially. In order to balance the air cushion associated with each channel, it has been found desirable to balance the volume through the manifold associated with each channel. In the preferred embodiment of the invention, this is accomplished by providing a volume adjusting chamber 232 coincidental with the holes 224 on the upper surface 220 of the upper manifold plate 218. This concept is best illustrated by referring to FIGS. 14, and cross-sectional views 16 and 17. The shortest channel of the four channels depicted in FIGS. 16 and 17 is channel 228a with the next longest channel being 228b, the third longest channel being 228c and the longest channel being 228d. Since the intention is to balance the overall volume through the upper manifold plate 218 for each channel of the pipettor, the volume adjusting chamber for 232a has a larger volume than the volume for chamber 232b, which in turn is larger than the volume for 232c, and which in turn is greater than the volume for 232d. By way of example, the volume of the longest channel in the manifold for the preferred 12-channel, 1250μ liter or 300μ liter pipettor is 18μ liters with the volume of the shortest channel being 1.75μ liters. The longest channel has an associated volume adjusting chamber of 0μ liters whereas the shortest channel has an associated volume adjusting chamber of 16.25μ liters. In this manner, the air cushion for each of the air passageways through the manifold from the aspiration cylinder block to the series of mounting shafts is balanced, thereby improving tip-to-tip pipetting accuracy.

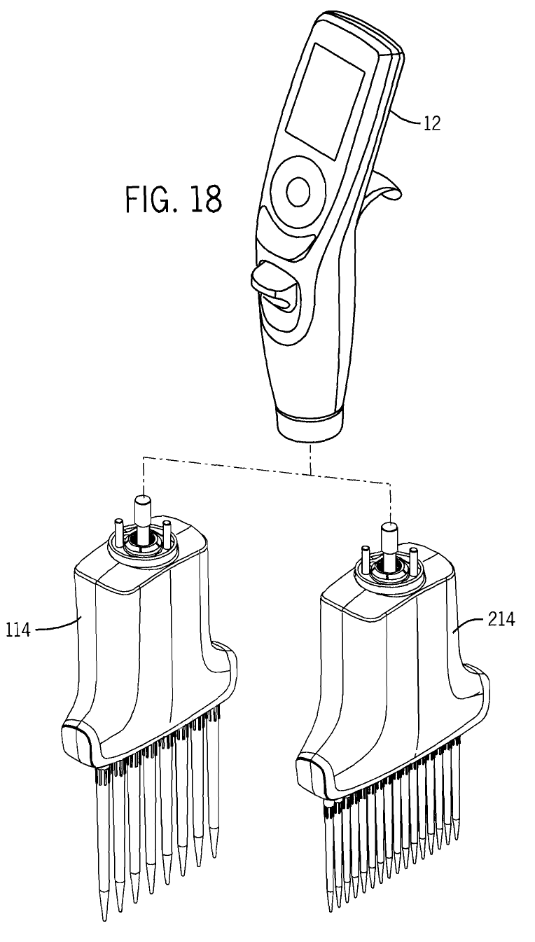

FIG. 18 is a schematic illustration showing an upper handle assembly 12, as well as detached lower assemblies 114 and 214. The lower multi-channel assembly 114 is an 8-channel drive assembly whereas the lower assembly 214 is a 16-channel drive assembly. Notably, while the tip-to-tip spacing is larger for the 8-channel drive assembly 114 shown in FIG. 18, both lower drive assemblies 114, 214 are relatively compact. The mechanical aspects of the invention described herein can be used in connection with either drive assembly 114 or 214, or for lower drive assemblies having more or less number of channels. While the pipettor 10 can be made so that it can accommodate various lower drive assemblies 114, 214, it is necessary that the upper handle assembly 12 be programmed to accommodate the appropriate lower multi-channel assembly and therefore such changes are probably best suited to be done by the manufacturer.

We claim:

1. A hand-held, multi-channel electronic pipettor comprising:
a handle portion containing a motor and an output shaft that is driven by the motor and moves upward to aspirate and downward to dispense; and
a lower portion having:
a cylinder block having multiple aspiration cylinders,
a main piston drive shaft attached at its upper end to the output shaft of the handle portion and at its lower end to a piston drive plate,
multiple pistons extending downward from the piston drive plate, each piston being disposed for reciprocating movement within one of the multiple aspiration cylinders,
a plurality of pipette mounting shafts each having an internal airflow duct, and
a manifold having a plurality of air flow passageways each connecting a bottom portion of one of the multiple aspiration cylinders to an internal air flow duct of one of the pipette mounting shafts, wherein the volumes of each of the air flow passageways in the manifold are substantially the same.

2. A hand-held, multi-channel electronic pipettor as recited in claim 1 wherein the manifold comprises:
an upper manifold plate having a plurality of openings on an upper surface corresponding to the location of a bottom of one of the aspiration cylinders, and a plurality of channels on a lower surface, each channel extending from one of the holes; and
a lower manifold plate having a plurality of holes corresponding to the location of the end of each channel in the upper manifold plate.

3. A hand-held, multi-channel electronic pipettor as recited in claim 2 further comprising a sealing gasket with openings corresponding to the location of the holes in the lower manifold plate, the gasket being located between the upper manifold plate and the lower manifold plate.

4. A hand-held, multi-channel electronic pipettor as recited in claim 3 wherein a beaded edge extends around each channel in the upper manifold plate to form a seal with the sealing gasket.

5. A hand-held, multi-channel electronic pipettor as recited in claim 2 wherein the upper manifold plate further comprises volume adjusting chambers coinciding with each of the openings on the upper surface, wherein the volume of the chambers is such that the combined volume of the air flow passageways in the manifold are substantially the same.

6. A hand-held, multi-channel electronic pipettor as recited in claim 2 wherein the upper manifold plate is molded of fiber-filled polypropylene.

7. A hand-held, multi-channel electronic pipettor comprising:
a handle portion containing a motor and an output shaft that is driven by the motor and moves upward to aspirate and downward to dispense;
a lower multi-channel assembly comprising:
an internal frame,
a cylinder block attached to the frame, the cylinder block having multiple aspiration cylinders,
a main piston drive shaft attached at its upper end to the output shaft of the handle portion and at its lower end to a piston drive plate,
multiple pistons extending downward from the piston drive plate, each piston being disposed for reciprocating movement within one of the multiple aspiration cylinders,
a plurality of pipette mounting shafts, and
a manifold connecting the multiple aspiration cylinders to the pipette mounting shafts.

8. A hand-held, multi-channel electronic pipettor as recited in claim 7 wherein the internal frame of the lower multi-channel assembly comprises:
a top wall having an opening through which the main piston drive shaft resides; and
first and second sidewalls extending downward from the top wall, wherein the cylinder block is attached to each of the first and second sidewalls.

9. A hand-held, multi-channel electronic pipettor as recited in claim 7 wherein the manifold is attached to the cylinder block.

10. A hand-held, multi-channel electronic pipettor as recited in claim 9 wherein the pipettor further comprises a stripping mechanism which includes two push bars that are slidably mounted through the manifold, cylinder block and frame and are actuated for up and down movement by an ejector mechanism in the handle portion.

11. A hand-held, multi-channel electronic pipettor as recited in claim 7 wherein the frame is molded from glass filled nylon.

12. A hand-held, multi-channel electronic pipettor comprising:
a handle assembly containing a motor and an output shaft that is driven by the motor and move upward to aspirate and downward to dispense;
a lower multi-channel assembly having:
a cylinder block with multiple aspiration cylinders,
a main piston drive shaft attached at its lower end to a piston drive plate,
multiple pistons extending downward from the piston drive plate, each piston being disposed for reciprocating movement within one of the multiple aspiration cylinders,
a plurality of pipette mounting shafts, and
a manifold connecting the multiple aspiration cylinders to the pipette mounting shaft;
wherein the lower multi-channel assembly is attached to the handle assembly so that the main piston drive shaft in the lower assembly is attached to the output shaft of the upper assembly along a longitudinal axis and the lower assembly is able to rotate about the longitudinal axis to vary the angular position of the lower multi-channel assembly relative to the handle assembly; and
wherein the pipettor further comprises a position holding mechansim having a ratcheting surface facing downward from the bottom of the handle assembly and a mating ratcheting surface facing upward from the lower multi-channel assembly which when engaged allow the users to hold the relative position of the lower multi-channel assembly with respect to the handle assembly in a fixed angular position.

13. A hand-held, multi-channel electronic pipettor as recited in claim 12 wherein the position holding mechansim further comprises a spring which biases at least one of the ratcheting surfaces towards the other ratcheting surface for locking engagement.

14. A hand-held, multi-channel electronic pipettor as recited in claim 12 wherein the lower multi-channel assembly is removably attached from the handle assembly.

15. A hand-held, multi-channel electronic pipettor as recited in claim 14 wherein the output shaft from the handle assembly is removably attached to an upper end of the main piston drive shaft such that the main piston drive shaft is allowed to rotate with respect to the output shaft on the handle assembly.

16. A hand-held, multi-channel electronic pipettor as recited in claim 12 wherein the pipettor further comprises an ejector mechanism which includes an ejector actuation mechanism in the handle assembly which comprises a substantially circular ejection collar that provides an interface for engaging a multi-channel ejection mechanism in the lower multi-channel assembly throughout a full range of angular positions for which the lower multi-channel assembly can be set relative to the handle assembly.

17. A hand-held, multi-channel electronic pipettor as recited in claim 12 further comprising a stop mechanism that limits the rotation of the lower assembly about the longitudinal axis relative to the handle assembly to less than one full revolution.

18. A hand-held, multi-channel electronic pipettor comprising:
a handle portion containing a motor and an output shaft that is driven by the motor and moves upward to aspirate and downward to dispense; and
a lower portion having:
a cylinder block having multiple aspiration cylinders,
a main piston drive shaft attached at its upper end to the output shaft of the handle portion and at its lower end to a piston drive plate,
multiple pistons extending downward from the piston drive plate, each piston being disposed for reciprocating movement within one of the multiple aspiration cylinders,
a plurality of pipette mounting shafts each having an internal airflow duct, and
a manifold having a plurality of air flow passageways each connecting a bottom portion of one of the multiple aspiration cylinders to an internal air flow duct of one of the pipette mounting shafts,
wherein the manifold comprises:
an upper manifold plate having a plurality of openings on an upper surface corresponding to the location of a bottom of one of the aspiration cylinders, and a plurality of channels on a lower surface, each channel extending from one of the holes; and
a lower manifold plate having a plurality of holes corresponding to the location of the end of each channel in the upper manifold plate.

19. A hand-held, multi-channel electronic pipettor as recited in claim 18 further comprising a sealing gasket with openings corresponding to the location of the holes in the lower manifold plate, the gasket being located between the upper manifold plate and the lower manifold plate.

20. A hand-held, multi-channel electronic pipettor as recited in claim 19 wherein a beaded edge extends around each channel in the upper manifold plate to form a seal with the sealing gasket.

21. A hand-held, multi-channel electronic pipettor as recited in claim 18 wherein the upper manifold plate is welded to the lower manifold plate.

22. A hand-held, multi-channel electronic pipettor as recited in claim 21 wherein the manifold is welded to the cylinder block.

23. A hand-held, multi-channel electronic pipettor comprising:
a handle assembly containing a stationary motor chassis, a motor and an output shaft that is driven by the motor and moves upward to aspirate and downward to dispense;
a lower multi-channel assembly comprising:
an internal frame,
a cylinder block attached to the frame, the cylinder block having multiple aspiration cylinders,
a main piston drive shaft attached at its upper end to the output shaft of the handle portion and at its lower end to a piston drive plate,
multiple pistons extending downward from the piston drive plate, each piston being disposed for reciprocating movement within one of the multiple aspiration cylinders,
a plurality of pipette mounting shafts, and
a manifold connecting the multiple aspiration cylinders to the pipette mounting shafts; and
wherein the motor chassis, internal frame, cylinder block and manifold are attached to one another to form a unitary structural member.
